(19) United States
(12) Patent Application Publication
(10) Pub. No.: US 2022/0400544 A1
(43) Pub. Date: Dec. 15, 2022

(54) DISTRIBUTED LIGHTING FIXTURES WITH CONSTANT CURRENT SOURCE

(71) Applicant: SIGNIFY HOLDING B.V., Eindhoven (NL)

(72) Inventors: RAYMOND GEORGE JANIK, FAYETTEVILLE, GA (US); RUSSELL SCOTT TRASK, SHARPSBURG, GA (US)

(21) Appl. No.: 17/770,082

(22) PCT Filed: Oct. 20, 2020
(86) PCT No.: PCT/EP2020/079483

§ 371 Date: Apr. 19, 2022

Related U.S. Application Data
(60) Provisional application No. 62/926,968, filed on Oct. 28, 2019.

(51) Int. Cl. H05B 45/345; F21V 21/35

(52) U.S. Cl. CPC H05B 45/345; F21V 21/35

(57) ABSTRACT

A lighting system having a main direct current (DC) voltage source and controllable lighting fixtures that each have a DC-DC current source. Each lighting fixture includes a DC voltage to current converter and an LED light source, and the DC voltage to current converter outputs a constant current from the DC voltage provided by a AC-to-DC converter. The output current of the DC voltage to current converter is independent of the total number of lighting fixtures in the lighting system and is controlled by injecting control commands to the DC voltage provided to DC-DC current source, wherein the AC power provided to the AC-to-DC converter is turned on and off to turn on and off the lights provided by the lighting fixtures of the lighting system and dimming and/or other lighting controls by injecting control commands into the DC voltage provided to the DC-DC current source.

### TECHNICAL FIELD

The present disclosure relates generally to lighting solutions, and more particularly to lighting fixtures that have a constant current source.

### BACKGROUND

A driver (e.g., an LED driver) is often used to provide power to the light sources of a lighting fixture. For example, a driver of a lighting fixture may be placed in or attached to a housing of the lighting fixture. In some lighting systems, alternating current (AC) power is provided to drivers of lighting fixtures, and each driver may provide constant current to a lighting source (e.g., an LED light source) of the respective lighting fixture. In some cases, providing AC power to a driver of a lighting fixture (e.g., a suspended lighting fixture) may not be convenient. For example, providing means for suspending a lighting fixture from a ceiling structure as well as safely and aesthetically routing AC power to the suspended lighting fixture may be challenging.

In some cases, dimming and other controls of lighting fixtures of a lighting system by controlling or adjusting the AC power provided to lighting fixtures may not be convenient. For example, adding a phase-cut dimmer to an already installed lighting system may be challenging. Further, changing a driver of a lighting fixture to add controllability may be costly and inconvenient. Thus, solutions that provide convenient installations of suspended lighting fixtures and that enable convenient controllability of lighting fixtures may be desirable.

### BRIEF DESCRIPTION OF THE FIGURES

Reference will now be made to the accompanying drawings, which are not necessarily drawn to scale, and wherein:

FIG. 1 illustrates a lighting system including suspended lighting fixtures with a DC-to-DC voltage-to-current converter circuit according to an example embodiment;

FIG. 2 illustrates a side view of the lighting system of FIG. 1 according to another example embodiment;

FIG. 3 illustrates a lighting system including a control signal injector unit according to an example embodiment;

FIG. 4A illustrates a control signal injector circuit of the control signal injector unit of FIG. 3 according to an example embodiment;

FIG. 4B illustrates an output voltage of the control signal injector circuit of FIG. 4A according to an example embodiment;

FIG. 5A illustrates a control signal injector circuit of the control signal injector unit of FIG. 3 according to another example embodiment;

FIG. 5B illustrates an output voltage of the control signal injector circuit of FIG. 5A according to an example embodiment;

FIG. 6A illustrates a control signal injector circuit of the control signal injector unit of FIG. 3 according to another example embodiment;

FIG. 6B illustrates an output voltage of the control signal injector circuit of FIG. 5A according to an example embodiment; and

FIG. 7 illustrates a lighting fixture corresponding to the lighting fixtures of the lighting system of FIG. 3 according to an example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals used in different drawings may designate like or corresponding, but not necessarily identical elements.

### DETAILED DESCRIPTION OF THE EXAMPLE EMBODIMENTS

In the following paragraphs, example embodiments will be described in further detail with reference to the figures. In the description, well known components, methods, and/or processing techniques are omitted or briefly described. Furthermore, reference to various feature(s) of the embodiments is not to suggest that all embodiments must include the referenced feature(s).

In some example embodiments, a lighting system may include a main direct current (DC) voltage source and controllable lighting fixtures that each have a DC-DC current source. The main DC voltage source may include an AC-to-DC converter and may supply DC power to a number of the lighting fixtures. Each lighting fixture includes a DC voltage to current converter and an LED light source, and the DC voltage to current converter outputs a constant current from the DC voltage provided by the AC-to-DC converter. The output current of the DC voltage to current converter is independent of the total number of lighting fixtures in the lighting system and may be controlled by injecting control commands to the DC voltage provided to DC-DC current source. For example, the AC power provided to the AC-to-DC converter may be turned on and off to turn on and off the lights provided by the lighting fixtures of the lighting system and dimming and/or other lighting controls may be performed by injecting control commands into the DC voltage provided to the DC-DC current source. The DC-DC current source in each lighting fixture of the lighting system may extract the injected command and control the current provided to the light source of the respective lighting fixture accordingly.

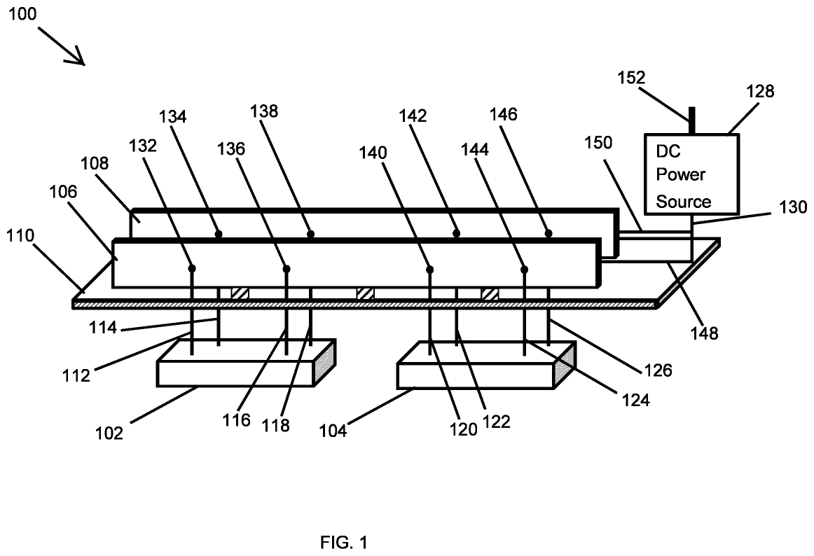

Turning now to the figures, particular embodiments are described. FIG. 1 illustrates a lighting system 100 including suspended lighting fixtures 102, 104 with a respective DC-DC voltage-to-current converter according to an example embodiment. In some example embodiments, the lighting fixtures 102, 104 are suspended from conductive support bars 106, 108 that are located behind a ceiling 110. The conductive support bars 106, 108 are each electrically conductive and provide support for the lighting fixtures 102, 104 while providing a path for electrical power to be provided to the lighting fixtures 102, 104. For example, the conductive support bars 106, 108 may be made from steel, copper, and/or another electrically conductive material.

In some example embodiments, the lighting system 100 also includes a DC voltage source 128 that generates a DC output voltage (i.e., voltage source output voltage). For example, the DC voltage source 128 may output DC output voltage on an electrical connection 130. The DC voltage source 128 may generate the DC output voltage from AC power received via an electrical connection 152. For example, the DC voltage source 128 may receive the AC power from the mains power supply. The DC output voltage generated by the DC voltage source 128 may be less than 60 volts. In general, the DC voltage source 128 is a class 2 power source. The DC voltage source 128 may be located behind the ceiling 110. Alternatively, the DC voltage source 128 may be located in an electrical box built in a wall.

In some example embodiments, the lighting fixtures 102, 104 are suspended down from the conductive support bars 106, 108 by support cables 112-126. For example, the lighting fixture 102 may be suspended down from the conductive support bar 106 by cables 112, 116 and from the conductive support bar 108 by cables 114, 118. The cable 112 may be attached to the conductive support bar 106 by an attachment structure 132 at one end and may be attached to the lighting fixture 102 at another end. The cable 114 may be attached to the conductive support bar 108 by an attachment structure 134 at one end and may be attached to the lighting fixture 102 at another end. The cable 116 may be attached to the conductive support bar 106 by an attachment structure 136 at one end and may be attached to the lighting fixture 102 at one end and may be attached to the lighting fixture 102 at another end. The cable 118 may be attached to the conductive support bar 108 by an attachment structure 138 at one end and may be attached to the lighting fixture 102 at another end. To illustrate, the cables 112-118 may be attached to the housing of the lighting fixture 102 by a respective fastener or another means as can be readily contemplated by those of ordinary skill in the art with the benefit of this disclosure. For example, the cables 112-118 may be attached the housing of the lighting fixture 102 insulated from the housing by a respective insulator.

In some example embodiments, the attachment structures 132-138 may each be a fastener that is attached to the respective conductive support bar 106, 108. For example, the attachment structures 132-138 may each be a tab, a hook, or another structure that is attached to or otherwise extends out from the respective conductive support bar 106, 108. To illustrate, the cables 112-118 may each include a connector, a loop, etc. that allows the respective attachment structure 132-138 to extend therethrough. The attachment structures 132-138 may be integrally formed with the respective conductive support bar 106, 108 or may be soldered to, screwed onto, or otherwise attached to the respective conductive support bar 106, 108.

In some example embodiments, the cables 116, 118 may be electrically conductive cables. For example, an inner portion of each cable 116, 118 may be made from copper and an outer portion of the cables 116, 118 surrounding the inner portion may be made from steel. Alternatively, the cables 116, 118 may be from a single metal, from different metals, and/or from different arrangements of metals. The cables 112, 114 may be the same type of cable as the cables 116, 118. For example, the cables 112, 114 may be electrically conductive cables. Alternatively, the cables 112, 114 may be a different type of cable from the cables 116, 118. For example, the cables 112, 114 may not electrically conductive cables.

In some example embodiments, the lighting fixture 104 may be suspended from the conductive support bars 106, 108 by the cables 120-126 in a similar manner as described with respect to the lighting fixture 102. To illustrate, the cables 120-122 may be the same type as the cables 112-114 and may be attached to the conductive support bars 106, 108 by attachment structures 140-146 at one end and may be attached to the lighting fixture 104 at an opposite end. For example, the cables 124, 126 may be electrically conductive cables. The attachment structures 140-146 may be the same type as the attachment structures 132-138. The attachment structures 140-146 may be made from an electrically conductive material such as steel, copper, and/or another suitable material.

In some example embodiments, the electrical cable 130, the conductive support bars 106, 108, and at least some of the support cables 112-126 may provide electrical paths the DC voltage source 128 to provide power to the lighting fixtures 102, 104. To illustrate, the electrical cable 130 may include electrical wires 148, 150 that are electrically coupled to a respective one of the conductive support bars 106, 108. For example, the electrical wire 148 may be electrically coupled to the conductive support bar 106, and the electrical wire 150 may be electrically coupled to the conductive support bar 108. At least some of the support cables 112-126 may provide electrical paths between the support bars 106, 108 and the lighting fixture 102, 104. Some of the support cables 112-126 may be electrically coupled to a respective DC-DC voltage-to-current converter inside of the lighting fixtures 102, 104.

By including DC-DC voltage-to-current converters inside the lighting fixtures 102, 104 and by providing to the DC-DC voltage-to-current converters a voltage that is below 60 V or otherwise compliant with class 2 power requirements, the conductive support bars 106, 108 may be exposed behind the ceiling 110 while providing support to suspend the lighting fixtures 102, 104 below the ceiling 110. Because the support cables 112-114 may also include externally exposed metal, the support cables 112-114 may extend through the ceiling 110 and may be used to suspend the lighting fixtures 102, 104 down from the bars 106, 108 while providing electrical paths for power to be provided to the lighting fixtures 102, 104.

In some alternative embodiments, the lighting system 100 may include more or fewer lighting fixtures than shown without departing from the scope of this disclosure. In some alternative embodiments, the bars 106, 108 and the support cables 112-126 may have different shapes than shown without departing from the scope of this disclosure. The attachment structures 132-146 may be at different locations or may have different shapes than shown without departing from the scope of this disclosure.

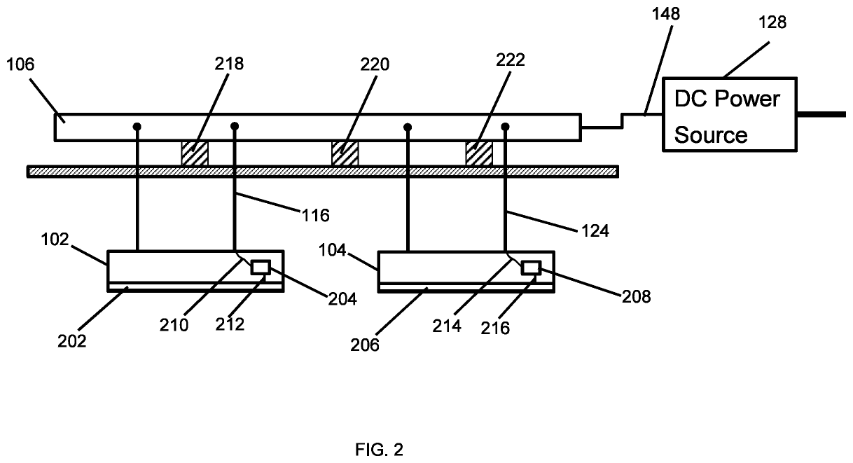

FIG. 2 illustrates a side view of the lighting system 100 of FIG. 1 according to another example embodiment. Referring to FIGS. 1 and 2, in some example embodiments, the lighting fixture 102 may include a light source 202 (e.g., one or more LED light sources) and a DC-DC voltage-to-current converter 204 (i.e., a constant current source), and the lighting fixture 104 may include a light source 206 (e.g., one or more LED light sources) and a DC-DC voltage-to-current converter 208 (i.e., a constant current source).

The DC-DC voltage-to-current converter 204 may receive the DC voltage from the DC voltage source 128 and provide a DC constant current to the light source 202. The DC output voltage generated by the DC voltage source 128 may be provided to the DC-DC voltage-to-current converter 204 via the cable 130, the bars 106, 108, the support cables 116, 118 as well as an electrical wire 210 and another electrical wire coupled to the support cable 118 and to the DC-DC voltage-to-current converter 204. The electrical wire 210 may be coupled to the support cable 116 or may be an integral part of the support cable 116. The DC-DC voltage-to-current converter 204 may provide a DC constant current to the light source 202 via an electrical connection 212.

In some example embodiments, the DC-DC voltage-to-current converter 208 may receive the DC voltage from the DC voltage source 128 and provide a DC constant current to the light source 206. The DC output voltage generated by the DC voltage source 128 may be provided to the DC-DC voltage-to-current converter 208 via the cable 130, the bars 106, 108, the support cables 124, 126 as well as an electrical wire 214 and another electrical wire coupled to the support cable 126 and to the DC-DC voltage-to-current converter 208. The electrical wire 214 may be coupled to the support cable 124 or may be an integral part of the support cable 124. The DC-DC voltage-to-current converter 208 may provide a DC constant current to the light source 202 via an electrical connection 216.

In some example embodiments, each DC-DC voltage-to-current converter 204, 208 generates the output constant current independent of the other, and thus the current provided by each DC-DC voltage-to-current converter 204, 208 to the respective light source 202, 206 may not be affected by changes to the output current of the other. To illustrate, if the light source 202 stops emitting a light, the output current provided by the DC-DC voltage-to-current converter 208 can remain unaffected.

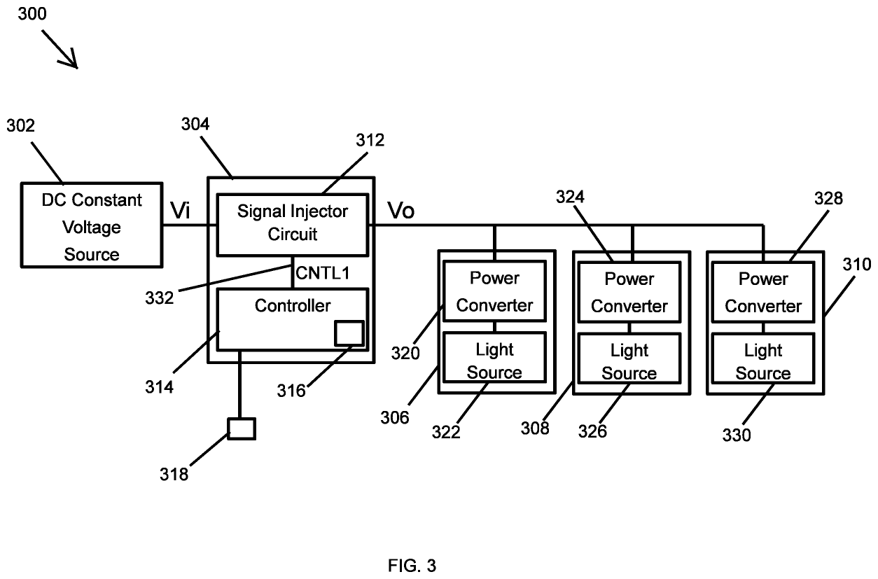

In some example embodiments, the dimming of the illumination lights provided by the light sources 202, 204 may be controlled in a manner described in U.S. patent application Ser. No. 16/175,448. Alternatively or in addition, the dimming and/or other controls of the illumination lights provided by the light sources 202, 204 may be controlled in a manner described with respect to FIGS. 3-7.

In some example embodiments, the conductive support bars 106, 108 may be positioned on ceiling structures 218-222. For example, the ceiling structures 218-222 may be wood structures or other non-conductive structures. Alternatively, the ceiling structures 218-222 may be made from an electrically conductive material, and the conductive support bars 106, 108 may each be separated from the ceiling structures 218-222 by a respective insulator.

In some example embodiments, the electrical wire 148 of the cable 130 may be attached to either one of the bars 106, 108, and the electrical wire 150 of the cable 130 may be attached to the other one of the bars 106, 108 regardless of the polarity of the DC output voltage provided by the DC voltage source 128. For example, each DC-DC voltage-to-current converter 204, 208 may include a rectifier (e.g., a synchronous rectifier) that allows subsequent components to be attached independent of the polarity of the DC output voltage at the input of the DC-DC voltage-to-current converter 204, 208.

FIG. 3 illustrates a lighting system 300 including a control signal injector unit 304 according to an example embodiment. In some example embodiments, the lighting system 300 includes a DC voltage source 302, the control signal injector unit 304, and lighting fixtures 306-310. For example, the DC voltage source 302 may correspond to the DC voltage source 128 shown in FIG. 1, and the lighting fixtures 306-318 may be the lighting fixtures of the lighting system 100 of FIG. 1. In some example embodiments, the lighting system 300 may correspond to the lighting system 100 that includes the control signal injector unit 304, for example, between the DC voltage source 128 and the support bars 106, 108.

In some example embodiments, the DC voltage source 302 may output a DC output voltage Vi, and the control signal injector unit 304 may receive the DC output voltage Vi and inject control information (e.g., a lighting control command) included in a control signal to the DC output voltage Vi. For example, the DC output voltage Vi may be less than 60 VDC. As a nonlimiting example, the DC output voltage Vi may be 24 volts. The control signal injector unit 304 may generate an output voltage signal Vo based on the DC output voltage Vi and the injected control signal. For example, the injected control signal may result in the output voltage signal Vo having a different voltage level from the DC output voltage Vi, for example, by 5%, 10%, 20%, or another percentage. In general, the voltage level of the output voltage signal Vo may remain below 60 Volts even when the control signal is injected onto the DC output voltage Vi. When no control signal is injected, the output voltage signal Vo may match the DC output voltage Vi. Alternatively, the voltage level of the output voltage signal Vo may have a different level from the DC output voltage Vi even when no control signal is injected onto the DC output voltage Vi.

In some example embodiments, each lighting fixture 306-310 may include a power converter and a light source (e.g., one or more LED light sources). For example, the lighting fixture 306 may include a power converter 320 and a light source 322. The lighting fixture 308 may include a power converter 324 and a light source 326. The lighting fixture 330 may include a power converter 328 and a light source 330. Each power converter 320, 324, 328 may receive the output voltage Vo and generate a constant current that is provided to the respective light source 322, 326, 330 based on the output voltage Vo that includes the control signal injected by the control signal injector unit 304.

In some example embodiments, the control signal injector unit 304 may include a signal injector circuit 312 and a controller 314. The controller 314 may receive a user input from a user control device 318 (e.g., a wallstation, a dimmer, etc.) and provide, via an electrical connection 332, a control signal CNTL1 to the signal injector circuit 312 that injects the control signal CNTL1 into the DC output voltage Vi. For example, the controller 314 may generate the control signal CNTL1 from the user input or may pass the user input to the signal injector circuit 312 without modification. Alternatively or in addition, the controller 314 may include a receiver 316 (or a transceiver) that receives a user input wirelessly, and the controller 314 may generate the control signal CNTL1 from the user input.

In some example embodiments, the control signal CNTL1 injected into the DC output voltage Vi may be include a sinusoidal signal, and particular message or command (e.g., dim level, color temperature, etc.) conveyed by the control signal CNTL1 may be related to the frequency of the sinusoidal signal, the amplitude of the sinusoidal signal, separations between sinusoidal signals, and/or another parameter of the sinusoidal signal. Alternatively or in addition, the control signal CNTL1 injected into the DC output voltage Vi may be a linearly changing signal where different voltage levels indicate different settings such as different desired dim levels, color temperature, or other characteristics of the illumination lights provided by the lighting fixtures 306-310. Alternatively or in addition, the control signal CNTL1 injected into the DC output voltage Vi may include pulses where the pulse widths of the pulses, the amplitude of the pulses, the number of pulses, and/or other parameters of the pulses may indicate different information such as desired dim levels, color temperature, a particular lighting fixture from among the lighting fixtures 306-310, and/or other information that can be used by the lighting fixture 306-310 to control the illumination light provided by the lighting fixtures 306-310.

In some alternative embodiments, the lighting system 300 may include more or fewer lighting fixtures than shown.

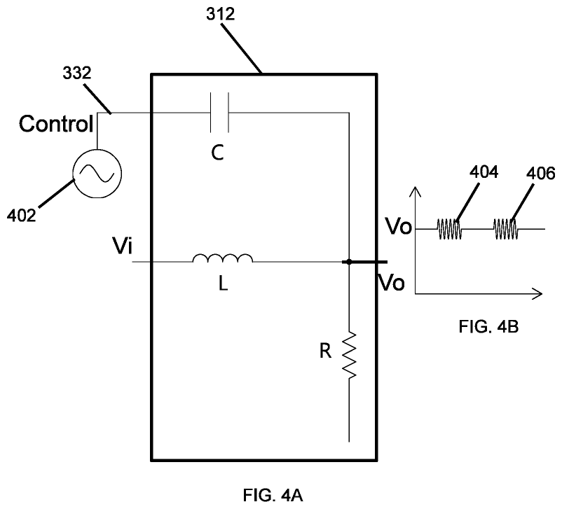

FIG. 4A illustrates the control signal injector circuit 312 of the control signal injector unit 304 of FIG. 3 according to an example embodiment. FIG. 4B illustrates an output voltage Vo of the control signal injector circuit 312 of FIG. 4A according to an example embodiment. Referring to FIGS. 3, 4A and 4B, in some example embodiments, the control signal injector circuit 312 may receive from the controller 314 a sinusoidal signal 402 as the control signal CNTL1 via the connection 332. The control signal injector circuit 312 may also receive the DC output voltage Vi and inject the sinusoidal signal into the DC output voltage Vi to generate the output voltage Vo. The sinusoidal signal 402 that includes control information (e.g., a lighting control command) may be generated and/or provided to the control signal injector circuit 312 by the controller 314 when a user input is provided to the control signal injector unit 304. When no user input is provided, the sinusoidal signal 402 may be replaced by a DC signal that can be ignored by the control signal injector circuit 312. In general, the amplitude of the sinusoidal signal 402 may be a percentage (e.g., 5%, 20%, 50%, etc.) of the DC output voltage Vi depending on the particular voltage level of the DC output voltage Vi.

In some example embodiments, the control signal injector circuit 312 may include a capacitor C that may block DC components, if any, of the control signal from contributing to the output voltage Vo. The control signal injector circuit 312 may also include an inductor L that may block AC components, if any, of the DC output voltage Vi from contributing to the output voltage Vo. The resistor R operates in conjunction with the capacitor C and the inductor L as can be readily understood by those of ordinary skill in the art with the benefit of this disclosure. The particular values of the capacitor C, the inductor L, and the resistor R may be selected based on a number of factors including the frequency of the sinusoidal signal 402.

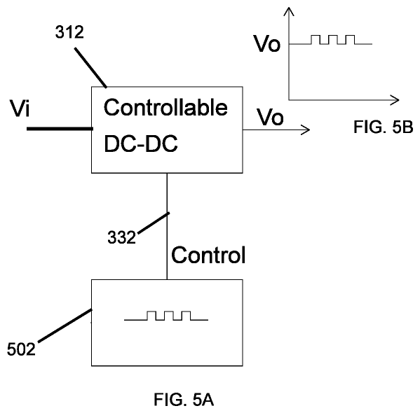

FIG. 5A illustrates the control signal injector circuit 312 of the control signal injector unit 304 of FIG. 3 according to another example embodiment. FIG. 5B illustrates an output voltage Vo of the control signal injector circuit of FIG. 5A according to an example embodiment. Referring to FIGS. 3, 5A and 5B, in some example embodiments, the control signal injector circuit 312 may receive from the controller 314 a pulse signal 402 as the control signal CNTL1 via the connection 332. The control signal injector circuit 312 may also receive the DC output voltage Vi and inject the pulse signal into the DC output voltage Vi to generate the output voltage Vo. The pulse signal 502 may be generated and/or provided to the control signal injector circuit 312 by the controller 314 when a user input is provided to the control signal injector unit 304. When no user input is provided, the pulse signal 502 may not include any pulses.

In some example embodiments, the control signal injector circuit 312 may include a controllable DC-DC circuit that generates the output voltage Vo based on the control pulse signal 502. For example, the control signal injector circuit 312 may inject the pulse signal 502 into the DC output voltage Vi to generate the output voltage Vo. In general, the amplitudes of the pulses of the pulse signal 502 may be a percentage (e.g., 5%, 20%, 50%, etc.) of the DC output voltage Vi depending on the particular voltage level of the DC output voltage Vi.

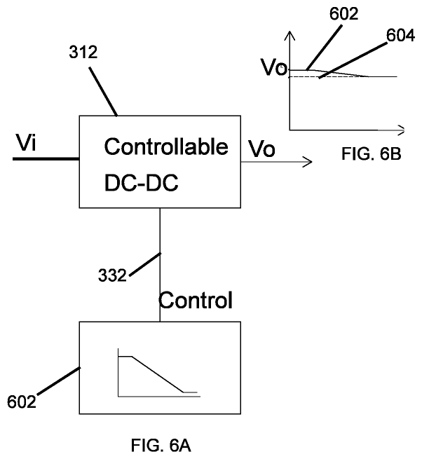

FIG. 6A illustrates the control signal injector circuit 312 of the control signal injector unit 304 of FIG. 3 according to another example embodiment. FIG. 6B illustrates an output voltage Vo of the control signal injector circuit 312 of FIG. 6A according to an example embodiment. Referring to FIGS. 3, 6A and 6B, in some example embodiments, the control signal injector circuit 312 may receive from the controller 314 a linear signal 602 as the control signal CNTL1 via the connection 332. The control signal injector circuit 312 may also receive the DC output voltage Vi and inject the linear signal into the DC output voltage Vi to generate the output voltage Vo. The linear signal 602 may be generated and/or provided to the control signal injector circuit 312 by the controller 314 when a user input is provided to the control signal injector unit 304. When no user input is provided, the linear signal 602 may not include the linear signal 602.

In some example embodiments, the control signal injector circuit 312 may include a controllable DC-DC circuit that generates the output voltage Vo based on the control pulse signal 602. The control signal injector circuit 312 may inject the linear signal 602 into the DC output voltage Vi to generate the output voltage Vo. As a nonlimiting example, the linear signal 602 may linearly range between 0 to 4 volts, and the DC output voltage Vi may be approximately 24 volts. In general, the linear signal 602 may linearly change within a range of a percentage (e.g., 5%, 20%, 50%, etc.) of the DC output voltage Vi depending on the particular voltage level of the DC output voltage Vi.

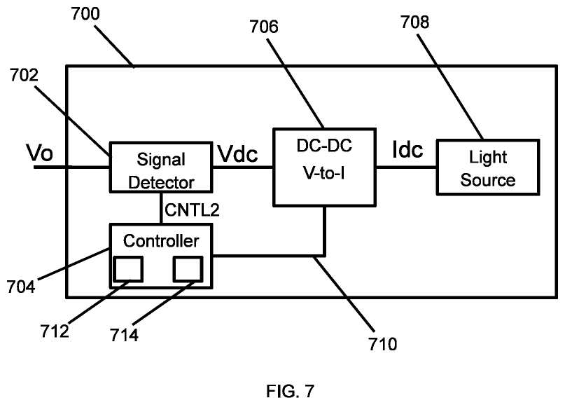

FIG. 7 illustrates a lighting fixture 700 corresponding to the lighting fixtures 306-310 of the lighting system 300 of FIG. 3 according to an example embodiment. Referring to FIGS. 3-7, in some example embodiments, the lighting fixture 700 includes a signal detector 702, a controller 704, a DC-DC voltage-to-current converter 706 (i.e., a constant current source), a light source (e.g., one or more LED light sources). In some example embodiments, the signal detector 702 may receive the output voltage Vo from the control signal injector unit 304 and output a DC voltage Vdc and a control signal CNTL2 (thus, control information included in the control signal CNTL2) from the output voltage Vo. For example, the DC voltage Vdc may correspond to the DC output voltage Vi provided to the control signal injector circuit 312, and the control signal CNTL2 may correspond to the control signal CNTL1 such as the signals 402, 502, 602 provided to the control signal injector circuit 312.

In some example embodiments, the signal detector 702 may include a high pass filter to extract the control signal CNTL1 (thus, control information included in the control signal CNTL1) and an analog-to-digital converter to generate a digital control signal CNTL2 from the control signal CNTL1 when the control signal CNTL1 corresponds to the sinusoidal signal 402. The signal detector 702 may also include a low pass filter to output the DC voltage Vdc without the control signal CNTL1. Alternatively, the DC voltage Vdc may include the control signal CNTL1, and the DC-DC voltage-to-current converter 706 may include a low pass filter to filter out the control signal CNTL1.

In some example embodiments, the signal detector 702 may include a comparator that compares the DC voltage Vdc to a reference voltage to determine whether the output voltage Vo includes the control signal CNTL1 corresponding to the pulse signal 502. For example, the control signal CNTL2 may be an output signal from the comparator, where the control signal CNTL2 includes pulses corresponding to the pulses of the pulse signal 502. The signal detector 702 may also include a circuit to filter out the pulses, when present, and output the DC voltage Vdc without the control signal CNTL1.

In some example embodiments, the signal detector 702 may include a difference amplifier that subtracts a reference voltage from the DC output voltage Vi to extract the control signal CNTL1 corresponding to the linear signal 602. The signal detector 702 may include an analog-to-digital converter to generate a digital control signal CNTL2 from the control signal CNTL1 extracted from the DC output voltage Vi. The signal detector 702 may also include a circuit to reject the control signal CNTL1 from the DC output voltage Vi and output the DC voltage Vdc without the control signal CNTL1.

In some example embodiments, the DC voltage Vdc is provided to the DC-DC voltage-to-current converter 706, and the control signal CNTL2 is provided to the controller 704. The controller 704 may process the control signal CNTL2 and generate a current control signal provided to the DC-DC voltage-to-current converter 706 via an electrical connection 710. For example, the controller 704 may include a microcontroller 712 (or a microprocessor) and a memory device 714 that stores software code that is executed by the microcontroller 712 to process the control signal CNTL2 and generate the current control signal that is provided to the DC-DC voltage-to-current converter 706.

In some example embodiments, the microcontroller 712 may process the control signal CNTL2 to determine a particular dim level, color temperature, and/or another parameter indicated by the control signal CNTL2 and corresponding to the user input provided to the control signal injector unit 304. For example, the microcontroller 712 may use a lookup table stored in the memory device 714 to generate the current control signal that is provided to the DC-DC voltage-to-current converter 706 based on the control signal CNTL2.

In some example embodiments, the control signal CNTL2 may include an address of a particular lighting fixture (e.g., one of the lighting fixtures 306-310) provided as the user input to the control signal injector unit 704, and the microcontroller 712 may determine whether the control signal CNTL2 is directed to the particular lighting fixture before generating the current control signal provided to the DC-DC voltage-to-current converter 706 via the electrical connection 710.

In some example embodiments, the DC-DC voltage-to-current converter 706 may receive the DC voltage Vdc from the signal detector 702 and generate a constant DC current Idc that is provided to the light source 708 from the DC voltage Vdc and based on the current control signal received from the controller 704 via the connection 710. For example, based on the current control signal, the DC-DC voltage-to-current converter 706 may adjust the constant DC current Idc between current levels that result in full dimming and full brightness of the light provided by the light source.

In some example embodiments, the signal detector 702 may include a rectifier (e.g., a synchronous rectifier) that enables the signal detector 702 to process the output voltage Vo regardless of polarity. For example, by using a rectifier, the signal detector 702 can enable the connection of the DC output voltage Vi generated by the DC voltage source 302 without the need for a particular polarity. In some alternative embodiments, the lighting fixture 700 may include more or fewer components than shown. In some alternative embodiments, the components of the lighting fixture 700 may be coupled in a different configuration than shown.

Although particular embodiments have been described herein in detail, the descriptions are by way of example. The features of the example embodiments described herein are representative and, in alternative embodiments, certain features, elements, and/or steps may be added or omitted. Additionally, modifications to aspects of the example embodiments described herein may be made by those skilled in the art without departing from the spirit and scope of the following claims, the scope of which are to be accorded the broadest interpretation so as to encompass modifications and equivalent structures.

1. A lighting system, comprising:
a direct-current (DC) voltage source configured to generate a DC voltage;
conductive support bars that are electrically coupled to the DC voltage source;
a first lighting fixture comprising a first light source and a first constant current source that provides a first DC current to the first light source, wherein the first constant current source is configured to generate the first DC current from the DC voltage provided to the first lighting fixture via the conductive support bars and a first set of conductive support cables that are attached to and extend down from the conductive support bars;
a second lighting fixture comprising a second light source and a second constant current source that provides a second DC current to the second light source, wherein the second constant current source is configured to generate the second DC current from the DC voltage provided to the second lighting fixture via the conductive support bars and a second set of conductive support cables that are attached to and extend down from the conductive support bars; and
a voltage source configured to output a direct-current (DC) voltage;
a control signal injector unit to receive a control signal including control information and add the control signal to the DC voltage to a generate an output voltage; and
a lighting fixture configured to extract the control signal from the output voltage and generate a constant current based on the control information and the DC voltage obtained from the output voltage, wherein the constant current is provided to a light source of the lighting fixture configured to emit an illumination light based on the constant current.

2. The lighting system of claim 1, wherein the first lighting fixture is suspended from the conductive support bars by the first set of conductive support cables.

3. The lighting system of claim 1, wherein the first set of support cables and the second set of support cables include a metal that is exposed.

4. The lighting system of claim 1, wherein conductive support bars include attachment structures for electrically attaching the first set of conductive support cables and the conductive second set of support cables to the conductive support bars.

5. The lighting system of claim 1, wherein the conductive support bars include a first conductive support bar and a second conductive support bar, wherein the DC voltage is provided to the conductive support bars via a first electrical wire coupled to the first conductive support bar and via a second electrical wire coupled to the second conductive support bar.

6. The lighting system of claim 1, wherein the DC voltage source is a class 2 voltage source.

7. (canceled)

8. The lighting system of claim 1, wherein the voltage source is a class 2 voltage source.
